(19) United States
(12) Patent Application Publication
(10) Pub. No.: US 2026/0359156 A1
(43) Pub. Date: Nov. 12, 2026

(54) MEMORY SYSTEM, ELECTRONIC SYSTEM, AND OPERATION METHOD THEREOF

(71) Applicant: Yangtze Memory Technologies Co., Ltd., Wuhan (CN)

(72) Inventors: Tianyi WANG, Wuhan (CN); Mo Cheng, Wuhan (CN)

(21) Appl. No.: 19/202,422

(22) Filed: May 8, 2025

(30) Foreign Application Priority Data
May 6, 2025 (CN) 202510579313.5

(51) Int. Cl. G06F 11/07; G06F 11/34

(52) U.S. Cl. CPC G06F 11/0757; G06F 11/0793; G06F 11/3476

(57) ABSTRACT

In certain aspects, a memory system, an electronic system, and operation methods thereof are provided. The electronic system includes a host and a memory system coupled to the host. The host is configured to send a first command to the memory system. The first command is configured to inquire an execution status of a program executed by the memory system. The memory system is configured to, responsive to receiving the first command, determine the execution status of the program, and return the execution status of the program to the host.

### CROSS-REFERENCE TO RELATED APPLICATIONS

This application claims the benefit of priority to Chinese Application No. 202510579313.5, filed on May 6, 2025, which is incorporated herein by reference in its entirety.

### BACKGROUND

The present disclosure relates to memory systems, electronic systems, and operation methods thereof.

Non-volatile storage devices such as solid-state drives (SSDs), non-volatile memory express (NVMe), embedded multimedia cards (eMMCs), and universal flash storage (UFS) devices, etc., have gained significant popularity in recent years due to their numerous advantages over traditional hard disk drives (HDDs), such as faster read and write speed, durability and reliability, reduced power consumption, silent operation, and smaller form factors. For example, non-volatile storage devices such as SSDs may use NAND Flash memory for non-volatile storage.

### SUMMARY

In one aspect, an electronic system is disclosed. The electronic system includes a host and a memory system coupled to the host. The host is configured to send a first command to the memory system. The first command is configured to inquire an execution status of a program executed by the memory system. The memory system is configured to, responsive to receiving the first command, determine the execution status of the program, and return the execution status of the program to the host.

In some implementations, the memory system includes a controller and a compute engine. The controller is configured to receive and parse a second command that instructs to execute the program. The compute engine is configured to execute the program responsive to the second command.

In some implementations, a compute namespace is implemented by the compute engine such that the program is executed in the compute namespace.

In some implementations, the controller is configured to receive the first command from the host. The compute engine is configured to determine the execution status of the program responsive to the first command. The controller is further configured to return the execution status of the program to the host.

In some implementations, the memory system further includes a first memory device accessible by the compute engine for the execution of the program and a second memory device. The controller is configured to copy input data of the program from the second memory device to the first memory device. The compute engine is configured to access the first memory device to retrieve the input data of the program from the first memory device and to store output data of the program in the first memory device.

In some implementations, the host is configured to send a third command to the memory system. The third command is configured to inquire whether the memory system supports an inquiry of the execution status of the program. Responsive to receiving the third command, the memory system is configured to return a response including indicative information to the host. The indicative information indicates whether the memory system supports the inquiry of the execution status of the program.

In some implementations, responsive to the indicative information indicating that the memory system supports the inquiry of the execution status of the program, the host is configured to send the first command to the memory system.

In some implementations, the third command includes an identify command. The response returned from the memory system to the host includes an input/output (I/O) command set specific identify namespace data structure for a computational programs command set. The indicative information includes a field in the I/O command set specific identify namespace data structure for the computational programs command set.

In some implementations, the execution status of the program includes an execution progress of the program. The memory system is configured to determine the execution progress of the program based at least in part on a type of the program, whether the program is being executed, or computing resources configured in the memory system.

In some implementations, the execution progress of the program includes at least one of a remaining execution time of the program or a percentage of the execution progress of the program.

In some implementations, the execution status of the program includes an abnormal execution status indicating that the program is hanging or the program is not being executed.

In some implementations, the first command includes a program index associated with the program.

In some implementations, the first command further includes an operation type indicating that a type of an operation of the first command is to query an execution progress of the program.

In some implementations, the first command includes a log page identifier (ID) used to identify a log page, and the execution status of the program is recorded in the log page. The memory system is configured to return the log page including the execution status of the program to the host.

In some implementations, responsive to the execution status of the program including an execution progress of the program, the host is configured to report the execution progress of the program to a user. Or, responsive to the execution status of the program including an abnormal execution status of the program, the host is configured to abort the execution of the program.

In another aspect, a memory system is disclosed. The memory system includes a controller configured to receive a first command. The first command is configured to inquire an execution status of a program. The memory system further includes a compute engine configured to execute the program, and determine the execution status of the program responsive to the first command. The controller is configured to return the execution status of the program to a host.

In some implementations, the controller is configured to receive and parse a second command that instructs to execute the program. The compute engine is configured to execute the program responsive to the second command.

In some implementations, the memory system further includes a first memory device accessible by the compute engine for the execution of the program and a second memory device. The controller is configured to copy input data of the program from the second memory device to the first memory device. The compute engine is configured to access the first memory device to retrieve the input data of the program from the first memory device and to store output data of the program in the first memory device.

In some implementations, the controller is configured to: receive a third command from the host, where the third command is configured to inquire whether the memory system supports an inquiry of the execution status of the program; and responsive to the third command, return a response including indicative information to the host, where the indicative information indicates whether the memory system supports the inquiry of the execution status of the program.

In some implementations, the third command includes an identify command. The response returned by the controller includes an I/O command set specific identify namespace data structure for a computational programs command set. The indicative information includes a field in the I/O command set specific identify namespace data structure for the computational programs command set.

In some implementations, the execution status of the program includes an execution progress of the program. The compute engine is configured to determine the execution progress of the program based at least in part on a type of the program, whether the program is being executed, or computing resources configured in the memory system.

In some implementations, the execution progress of the program includes at least one of a remaining execution time of the program or a percentage of the execution progress of the program.

In some implementations, the execution status of the program includes an abnormal execution status indicating that the program is hanging or the program is not being executed.

In some implementations, the first command includes a program index associated with the program.

In some implementations, the first command further includes an operation type indicating that a type of an operation of the first command is to query an execution progress of the program.

In some implementations, the first command includes a log page ID used to identify a log page, and the execution status of the program is recorded in the log page. The controller is configured to return the log page including the execution status of the program to the host.

In still another aspect, a method of operating a memory system is disclosed. The method includes executing a program in the memory system, receiving a first command configured to inquire an execution status of the program, determining the execution status of the program in the memory system responsive to the first command, and returning the execution status of the program to a host.

In some implementations, a compute namespace is implemented by a compute engine of the memory system, and the program is executed in the compute namespace.

In some implementations, the memory system further includes a first memory device accessible by the compute engine for the execution of the program and a second memory device. Input data of the program is copied from the second memory device to the first memory device. The first memory device is accessed by the compute engine to retrieve the input data of the program from the first memory device and to store output data of the program in the first memory device.

In some implementations, the method further includes: receiving a second command from the host, where the second command is configured to inquire whether the memory system supports an inquiry of the execution status of the program; and responsive to the second command, returning a response including indicative information to the host, where the indicative information indicates whether the memory system supports the inquiry of the execution status of the program.

In some implementations, the second command includes an identify command. The response includes an I/O command set specific identify namespace data structure for a computational programs command set. The indicative information includes a field in the I/O command set specific identify namespace data structure for the computational programs command set.

In some implementations, the execution status of the program includes an execution progress of the program. Determining the execution status of the program includes determining the execution progress of the program based at least in part on a type of the program, whether the program is being executed, or computing resources configured in the memory system.

In some implementations, the execution progress of the program includes at least one of a remaining execution time of the program or a percentage of the execution progress of the program.

In some implementations, the execution status of the program includes an abnormal execution status indicating that the program is hanging or the program is not being executed.

In some implementations, the first command includes a program index associated with the program.

In some implementations, the first command further includes an operation type indicating that a type of an operation of the first command is to query an execution progress of the program.

In some implementations, the first command includes a log page ID used to identify a log page, and the execution status of the program is recorded in the log page. Returning the execution status of the program includes returning the log page including the execution status of the program to the host.

### BRIEF DESCRIPTION OF THE DRAWINGS

The accompanying drawings, which are incorporated herein and form a part of the specification, illustrate aspects of the present disclosure and, together with the description, further serve to explain the principles of the present disclosure and to enable a person skilled in the pertinent art to make and use the present disclosure.

FIG. 1 illustrates a block diagram of an electronic system having a memory device, according to some aspects of the present disclosure.

FIG. 2A illustrates a diagram of a memory card having a memory device, according to some aspects of the present disclosure.

FIG. 2B illustrates a diagram of a solid-state drive (SSD) having a memory device, according to some aspects of the present disclosure.

FIG. 3 illustrates another block diagram of an electronic system having a memory device, according to some aspects of the present disclosure.

FIG. 4 illustrates a schematic diagram of a memory device including peripheral circuits, according to some aspects of the present disclosure.

FIG. 5A illustrates still another block diagram of an electronic system having a plurality of memory systems, according to some aspects of the present disclosure.

FIG. 5B illustrates yet another block diagram of an electronic system having a plurality of memory systems, according to some aspects of the present disclosure.

FIG. 6A illustrates a block diagram of a memory system, according to some aspects of the present disclosure.

FIG. 6B illustrates an example computational storage architecture including various types of namespaces, according to some aspects of the present disclosure.

FIG. 7 illustrates an example program execution process under the computational storage architecture of FIG. 6B, according to some aspects of the present disclosure.

FIG. 8 illustrates example memory range sets, according to some aspects of the present disclosure.

FIG. 9 illustrates a process of operating an electronic system, according to some aspects of the present disclosure.

FIG. 10 illustrates an input/output (I/O) command set specific identify namespace data structure for a computational programs command set, according to some aspects of the present disclosure.

FIG. 11 illustrates another example program execution process under the computational storage architecture of FIG. 6B, according to some aspects of the present disclosure.

FIG. 12 illustrates a flowchart of a method for operating a memory system, according to some aspects of the present disclosure.

FIG. 13 illustrates a flowchart of a method performed by a host, according to some aspects of the present disclosure.

The present disclosure will be described with reference to the accompanying drawings.

### DETAILED DESCRIPTION

Although specific configurations and arrangements are discussed, it should be understood that this is done for illustrative purposes only. As such, other configurations and arrangements can be used without departing from the scope of the present disclosure. Also, the present disclosure can also be employed in a variety of other applications. Functional and structural features as described in the present disclosures can be combined, adjusted, and modified with one another and in ways not specifically depicted in the drawings, such that these combinations, adjustments, and modifications are within the scope of the present disclosure.

In general, terminology may be understood at least in part from usage in context. For example, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

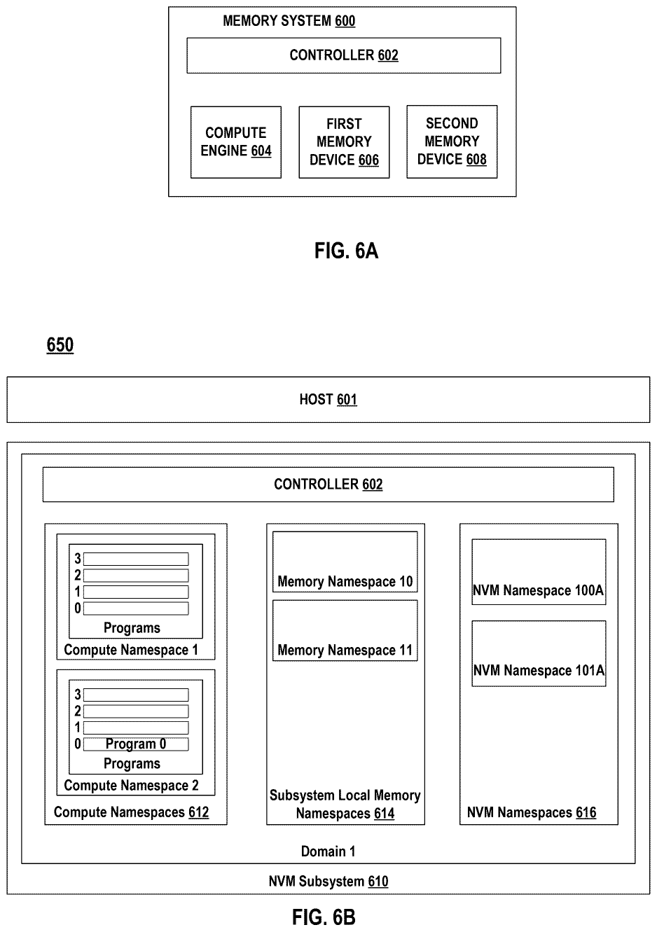

The NVM Express (NVMe) computational storage architecture involves various types of namespaces, including compute namespaces, memory namespaces, and non-volatile memory (NVM) namespaces (e.g., as shown in FIG. 6B below). A compute namespace can be a namespace that is associated with the Computational Programs Command Set. A NVM namespace can be a namespace that is associated with the NVM Command Set or the Zoned Namespace Command Set. A memory namespace can be a namespace that is associated with the Subsystem Local Memory Command Set.

Under the NVMe computational storage architecture, a host can offload execution of programs to a memory system (e.g., a computational storage device) coupled to the host. For example, the memory system may include at least (i) a compute engine used to implement a compute namespace and (ii) a memory device used to implement a memory namespace. A computational program, which can be device-defined or downloaded from the host, can operate on data in the memory namespace and be executed in the compute namespace. However, during the execution of the computational program, an execution status of the computational program is unknown to the host. There is no mechanism that enables the host to learn the execution status of the computational program when the program is being executed in the memory system. Especially when the computational program needs to be executed for a long time, a user operating on the host may not be able to learn the execution status (e.g., an execution progress) of the computational program in time during the execution of the program. For example, there is no execution feedback provided by the memory system to the host during the execution of the program. Thus, the host fails to notify the user in time whether the computational program is still being executed or is suspended.

To address one or more of the aforementioned issues, the present disclosure introduces a solution allowing a host to learn whether a memory system coupled to the host is able to feedback an execution status of a program when the program is executed in the memory system. If the memory system can provide the execution status of the program when the program is executed, the host may obtain the execution status of the program from the memory system in time. For example, the host may send a support inquiry command to the memory system to inquire whether the memory system supports an inquiry of the execution status of the program during the execution of the program. Responsive to receiving the support inquiry command, the memory system may return a response to the host, where the response includes indicative information indicating whether the memory system supports the inquiry of the execution status of the program. If the indicative information indicates that the memory system supports the inquiry of the execution status of the program, the host may send a status inquiry command to the memory system to inquire the execution status of the program executed by the memory system. Responsive to receiving the status inquiry command from the host, the memory system may determine the execution status of the program and return the execution status of the program to the host. As a result, the host may be able to provide the execution status of the program to a user operating on the host, such that the user can learn the execution status of the program in time.

By applying the solution disclosed herein, the host can learn an execution status of a program when the program is executed in the memory system. Especially for a program that needs to be executed for a long time (e.g., an artificial intelligence (AI) training program), the host can monitor an execution status of the program in the memory system. If the execution status of the program indicates that the program is hanging, the host may abort the execution of the program in time to save computing resources of the memory system. The host may also feedback the execution status to a user operating on the host, facilitating the user to learn the execution status of the program as needed.

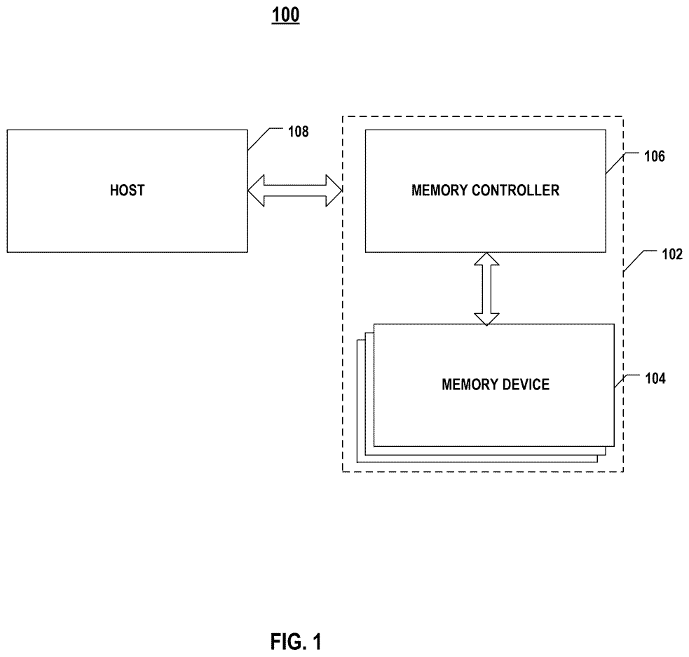

FIG. 1 illustrates a block diagram of a system 100 including a memory system 102, according to some aspects of the present disclosure. System 100 can be a mobile phone, a desktop computer, a laptop computer, a tablet, a vehicle computer, a gaming console, a printer, a positioning device, a wearable electronic device, a smart sensor, a virtual reality (VR) device, an argument reality (AR) device, or any other suitable electronic devices having storage therein. As shown in FIG. 1, system 100 can include a host 108 and memory system 102 having one or more memory devices 104 and a memory controller 106. Host 108 can include a processor of an electronic device, such as a central processing unit (CPU), or a system-on-chip (SoC), such as an application processor (AP). Host 108 can be configured to send or receive data (a.k.a. user data or host data) to or from memory system 102. Memory system 102 can be a storage product integrating memory controller 106 and one or more memory devices 104, such as an SSD.

Memory devices 104 can be any memory devices disclosed in the present disclosure, including non-volatile memory devices, such as NAND Flash memory devices. In some implementations, memory device 104 also includes one or more volatile memory devices, such as dynamic random-access memory (DRAM) devices or static random-access memory (SRAM) devices.

Memory controller 106 is operatively coupled to memory devices 104 and host 108 and is configured to control memory devices 104, according to some implementations. Memory controller 106 can manage the data stored in memory devices 104 and communicate with host 108. In some implementations, memory controller 106 is designed for operating in a low duty-cycle environment like secure digital (SD) cards, compact Flash (CF) cards, universal serial bus (USB) Flash drives, or other media for use in electronic devices, such as personal computers, digital cameras, mobile phones, etc. In some implementations, memory controller 106 is designed for operating in a high duty-cycle environment with SSDs or embedded multimedia card (eMMCs) used as data storage for mobile devices, such as smartphones, tablets, laptop computers, etc., and enterprise storage arrays. Memory controller 106 can be configured to control operations of memory devices 104, such as read, program/write, and/or erase operations. Memory controller 106 can also be configured to manage various functions with respect to the data stored or to be stored in memory devices 104 including, but not limited to bad-block management, garbage collection, logical-to-physical (L2P) address conversion, wear-leveling, etc. In some implementations, memory controller 106 is further configured to process error correction codes (ECCs) with respect to the data read from or written to memory devices 104. Any other suitable functions may be performed by memory controller 106 as well, for example, formatting memory devices 104. Memory controller 106 can communicate with an external device (e.g., host 108) according to a particular communication protocol. For example, memory controller 106 may communicate with the external device through at least one of various interface protocols, such as a non-volatile memory express (NVMe) protocol, an NVM e-over-fabrics (NVMe-oF) protocol, a PCI-express (PCI-E) protocol, a universal serial bus (USB) protocol, a multimedia card (MMC) protocol, a peripheral component interconnection (PCI) protocol, an advanced technology attachment (ATA) protocol, a serial-ATA protocol, a parallel-ATA protocol, a small computer small interface (SCSI) protocol, an enhanced small disk interface (ESDI) protocol, an integrated drive electronics (IDE) protocol, a Firewire protocol, etc.

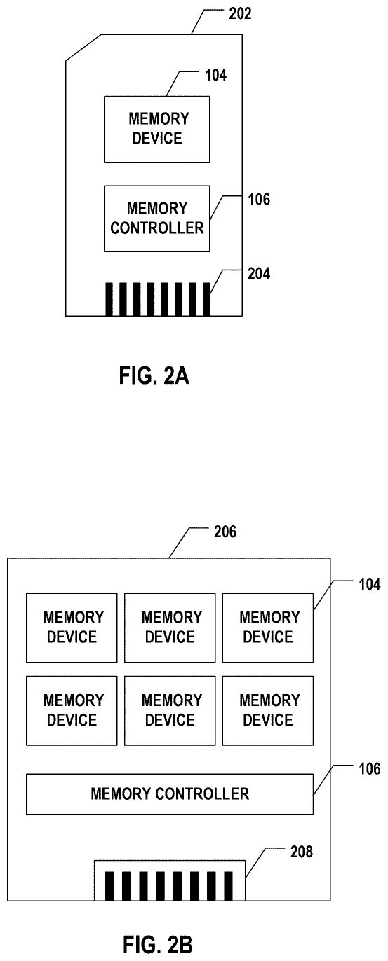

Memory controller 106 and one or more memory devices 104 can be integrated into various types of storage devices, for example, being included in the same package, such as a universal Flash storage (U FS) package or an eMMC package. That is, memory system 102 can be implemented and packaged into different types of end electronic products. In one example as shown in FIG. 2A, memory controller 106 and a single memory device 104 may be integrated into a memory card 202. Memory card 202 can include a PC card (PCM CIA, personal computer memory card international association), a CF card, a smart media (SM) card, a memory stick, a multimedia card (MMC, RS-MMC, MMC micro), an SD card (SD, miniSD, microSD, SDHC), a UFS, etc. Memory card 202 can further include a memory card connector 204 coupling memory card 202 with a host (e.g., host 108 in FIG. 1). In another example as shown in FIG. 2B, memory controller 106 and multiple memory devices 104 may be integrated into an SSD 206. SSD 206 can further include an SSD connector 208 coupling SSD 206 with a host (e.g., host 108 in FIG. 1). In some implementations, the storage capacity and/or the operation speed of SSD 206 is greater than those of memory card 202. In some implementations, memory system 102 is implemented as an SSD 206 that includes both non-volatile memory devices and volatile memory devices as memory devices 104, such as an enterprise SSD.

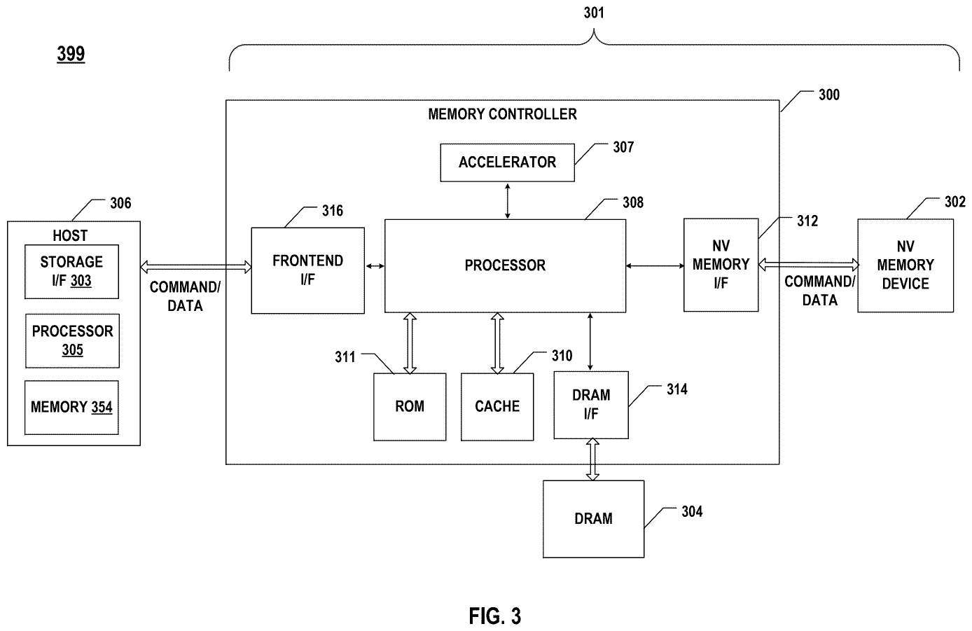

FIG. 3 illustrates another block diagram of a system 399, according to some aspects of the present disclosure. System 399 may be an example of system 100 in FIG. 1. System 399 may include a host 306 (e.g., an example of host 108 in FIG. 1) and a memory system 301 (e.g., an example of memory system 102 of FIG. 1). Memory system 301 may include a memory controller 300 (e.g., an example of memory controller 106 in FIG. 1) and a non-volatile memory device 302 (e.g., an example of memory device 104 in FIG. 1).

As shown in FIG. 3, memory controller 300 can include a processor 308, an accelerator 307 (e.g., a hardware accelerator), a cache 310, and a read-only memory (ROM) 311. In some implementations, processor 308 is implemented by microprocessors (e.g., digital signal processors (DSPs)) or microcontrollers (a.k.a. microcontroller units (MCUs)) that execute firmware and/or software modules to perform the various functions described herein. The various firmware modules in memory controller 300 described herein can be implemented as firmware codes or instructions stored in ROM 311 and executed by processor 308. In some implementations, processor 308 includes one or more hardware circuits, for example, fixed logic units such as a logic gate, a multiplexer, a flip-flop, a state machine, field-programmable gate arrays (FPGAs), programmable logic devices (PLDs). For example, the hardware circuits may include dedicated circuits performing a given logic function that is known at the time of device manufacture, such as application-specific integrated circuits (ASICs).

As shown in FIG. 3, memory controller 300 can also include various input/output (I/O) interfaces (I/F), such as a non-volatile memory interface 312, a DRAM interface 314, and a frontend interface 316 operatively coupled to non-volatile memory device 302 (e.g., flash memory), DRAM 304 (e.g., an example of volatile memory devices), and host 306, respectively. Non-volatile memory interface 312, DRAM interface 314, and frontend interface 316 can be configured to transfer data, command, clock, or any suitable signals between processor 308 and non-volatile memory device 302, DRAM 304, and host 306, respectively. Non-volatile memory interface 312, DRAM interface 314, and frontend interface 316 can implement any suitable communication protocols facilitating data transfer, communication, and management, such as the NVMe protocol and PCI-E protocol, double data rate (DDR) protocol, to name a few.

As described above, both cache 310 and DRAM 304 may be considered volatile memory devices that can be controlled and accessed by memory controller 300 in memory system 301. In some implementations, a cache can be implemented as part of volatile memory devices, for example, by an SRAM and/or DRAM 304. It is understood that although FIG. 3 shows that cache 310 is within memory controller 300 and DRAM 304 is outside of memory controller 300. In some examples both cache 310 and DRA M 304 may be within memory controller 300 or outside of memory controller 300.

Host 306 may include a storage interface (I/F) 303, a processor 305, and a memory 354. Storage interface 303 may be operatively coupled to frontend interface 316 of memory controller 300. Storage interface 303 may be configured to transfer data, command, or any suitable signals between host 306 and memory controller 300. Storage interface 303 can implement any suitable communication protocols facilitating data transfer, communication, and management, such as the NV M e protocol, the PCI-E protocol, SCSI, to name a few.

Processor 305 can include a Central Processing Unit (CPU), an Application Processor, a Graphics Processing Unit (GPU), a Neural Processing Unit (NPU), a Field Programmable Gate Array (FPGA) , or a microprocessor, etc. In some implementations, processor 305 can be implemented as a System on Chip (SoC). In some implementations, processor 305 may have a structure like that of processor 308, and the similar description will not be repeated herein.

Memory 354 may include any appropriate type of mass storage provided to store any type of information that processor 305 may need to operate. Memory 354 may be a volatile or non-volatile, magnetic, semiconductor, tape, optical, removable, non-removable, or other type of storage device or tangible (i.e., non-transitory) computer-readable medium including, but not limited to, a Read Only Memory (ROM) , a flash memory, a Dynamic Random Access Memory (DRAM), a Static Random Access Memory (SRAM) , a Synchronous Dynamic Random Access Memory (SDRAM), a Double Data Rate Synchronous Dynamic Random (DDR SDRAM), etc. Memory 354 may be configured to store one or more computer programs that may be executed by processor 305 to perform functions disclosed herein.

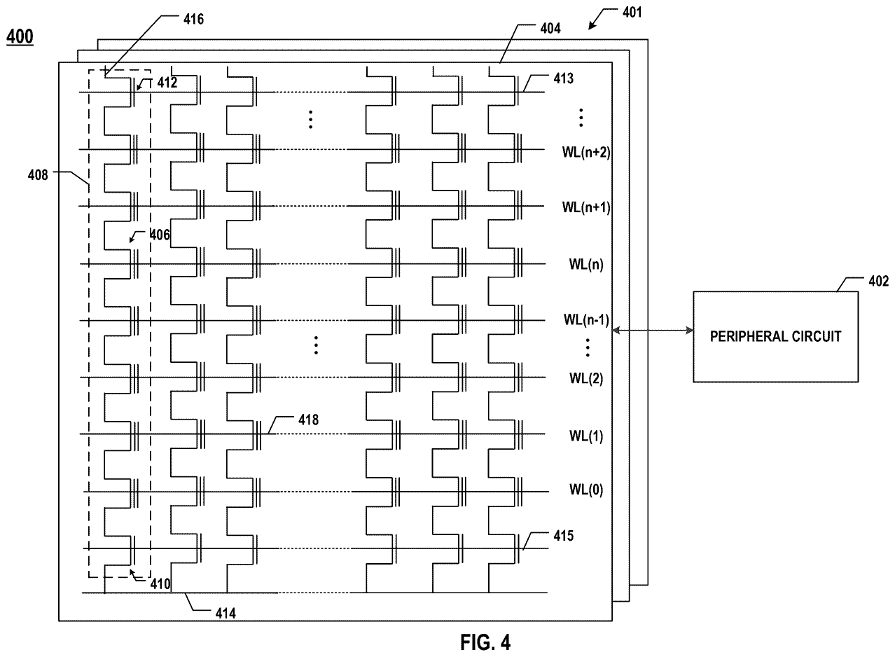

FIG. 4 illustrates a schematic diagram of a memory device 400 including peripheral circuits 402, according to some aspects of the present disclosure. Memory device 400 can be an example of memory device 104 in FIG. 1 or memory device 302 of FIG. 3. Memory device 400 can include a memory cell array 401 and peripheral circuits 402 coupled to memory cell array 401. Memory cell array 401 can be a NAND Flash memory cell array in which memory cells 406 are provided in an array of NAND memory strings 408 each extending vertically above a substrate (not shown). In some implementations, each NAND memory string 408 includes a plurality of memory cells 406 coupled in series and stacked vertically. Each memory cell 406 can hold a continuous, analog value, such as an electrical voltage or charge, that depends on the number of electrons trapped within a region of memory cell 406. Each memory cell 406 can be either a floating gate type of memory cell including a floating-gate transistor or a charge trap type of memory cell including a charge-trap transistor.

In some implementations, each memory cell 406 is a single-level cell (SLC) that has two possible memory states and thus, can store one bit of data. For example, the first memory state “0” can correspond to a first range of voltages, and the second memory state “1” can correspond to a second range of voltages. In some implementations, each memory cell 406 is a multi-level cell (MLC) that is capable of storing more than a single bit of data in more than four memory states. For example, the MLC can store two bits per cell, three bits per cell (also known as TLC), or four bits per cell (also known as QLC). Each MLC can be programmed to assume a range of possible nominal storage values. In one example, if each MLC stores two bits of data, then the MLC can be programmed to assume one of three possible programming levels from an erased state by writing one of three possible nominal storage values to the cell. A fourth nominal storage value can be used for the erased state.

As shown in FIG. 4, each NAND memory string 408 can also include a source select gate (SSG) transistor 410 at its source end and a drain select gate (DSG) transistor 412 at its drain end. SSG transistor 410 and DSG transistor 412 can be configured to activate select NAND memory strings 408 (columns of the array) during read and program operations. In some implementations, the sources of NAND memory strings 408 in the same block 404 are coupled through a same source line (SL) 414, e.g., a common SL. In other words, all NAND memory strings 408 in the same block 404 have an array common source (ACS), according to some implementations. The drain of each NAND memory string 408 is coupled to a respective bit line 416 from which data can be read or written via an output bus (not shown), according to some implementations. In some implementations, each NAND memory string 408 is configured to be selected or deselected by applying a DSG select voltage or a DSG unselect voltage to the gate of respective DSG transistor 412 through one or more DSG lines 413 and/or by applying an SSG select voltage or an SSG unselect voltage to the gate of respective SSG transistor 410 through one or more SSG lines 415.

As shown in FIG. 4, NAND memory strings 408 can be organized into multiple blocks 404, each of which can have a common source line 414, e.g., coupled to an A CS. In some implementations, each block 404 is the basic data unit for erase operations, i.e., all memory cells 406 on the same block 404 are erased at the same time. To erase memory cells 406 in a select block 404, source lines 414 coupled to select block 404 as well as unselect blocks 404 in the same plane as select block 404 can be biased with an erase voltage (Vers), such as a high positive voltage (e.g., 20 V or more). Memory cells 406 of adjacent NAND memory strings 408 can be coupled through word lines 418 that select which row of memory cells 406 is affected by read and program operations. Each word line 418 can include a plurality of control gates (gate electrodes) at each memory cell 406 coupled to word line 418 and a gate line coupling the control gates. With reference to FIG. 4, a plurality of word lines WL(0), WL(1), WL(2), . . . , WL(n−1), WL(n), WL(n+1), and WL(n+2) are illustrated, with n being a positive integer.

Peripheral circuits 402 can be coupled to memory cell array 401 through bit lines 416, word lines 418, source lines 414, SSG lines 415, and DSG lines 413. Peripheral circuits 402 can include any suitable analog, digital, and mixed-signal circuits for facilitating the operations of memory cell array 401 by applying and sensing voltage signals and/or current signals to and from each target memory cell 406 through bit lines 416, word lines 418, source lines 414, SSG lines 415, and DSG lines 413. Peripheral circuits 402 can include various types of peripheral circuits formed using metal-oxide-semiconductor (MOS) technologies.

Examples of peripheral circuits 402 may include, but are not limited to, a page buffer/sense amplifier, a column decoder/bit line driver, a row decoder/word line driver, a voltage generator, control logic configured to control the operations of each peripheral circuit, registers, etc. The page buffer/sense amplifier can be configured to read and program (write) data from and to memory cell array 401 according to control signals from the control logic. The column decoder/bit line driver can be configured to be controlled by the control logic and select one or more NAND memory strings 408 by applying bit line voltages generated from the voltage generator. The row decoder/word line driver can be configured to be controlled by the control logic and select/deselect blocks 404 of memory cell array 401 and select/deselect word lines 418 of block 404. The voltage generator may be configured to be controlled by the control logic and generate word line voltages (e.g., read voltage, program voltage, channel pass voltage, local voltage, verify voltage, etc.), bit line voltages, and source line voltages to be supplied to memory cell array 401. The registers may include status registers, command registers, and address registers for storing status information, command operation codes (OP codes), and command addresses for controlling the operations of each peripheral circuit.

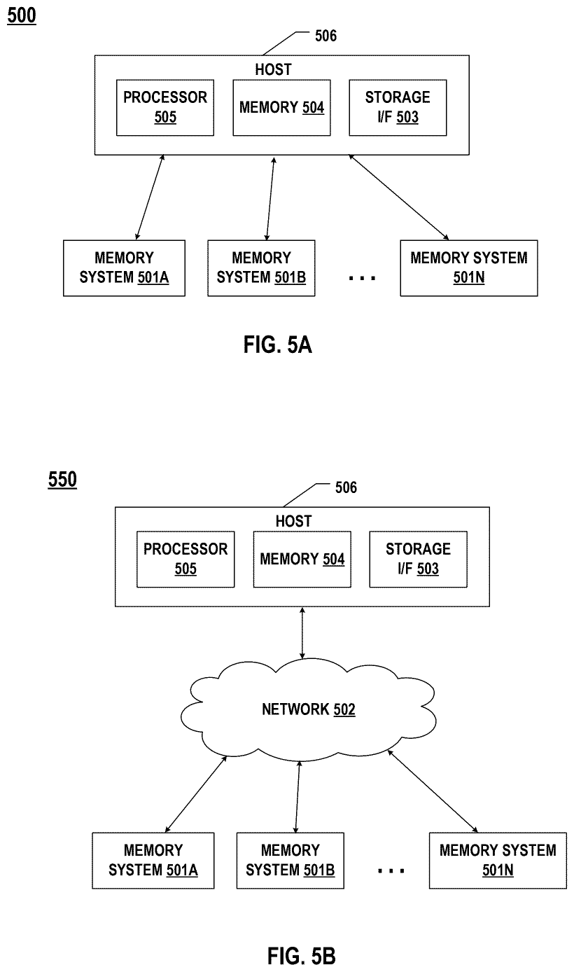

FIG. 5A illustrates still another block diagram of a system 500, according to some aspects of the present disclosure. System 500 may include a host 506 and a plurality of memory systems 501A, 501B, . . . , and 501N (also referred to as memory system 501, collectively or individually). FIG. 5B illustrates yet another block diagram of a system 550, according to some aspects of the present disclosure. System 550 may have components like those of system 500, where host 506 and memory systems 501A, 501B, . . . , and 501N in system 550 are coupled through a network 502.

Network 502 can include a partially public or a wholly public network such as the Internet. Network 502 can also include a private network or include one or more distinct or logical private networks (e.g., virtual private networks, Wide Area Networks (“WAN”) and/or Local Area Networks (“LAN”)). Additionally, the communication links to and from network 502 can be wireline or wireless (i.e., terrestrial-or satellite-based transceivers). In some implementations, network 502 can include an Internet Protocol (IP)-based wide or metropolitan area network.

Referring to FIGS. 5A and 5B, host 506 may be an example of host 108 in FIG. 1 or host 306 of FIG. 3, and memory systems 501A, 501B, . . . , and 501N may be examples of memory system 102 of FIG. 1 or memory system 301 of FIG. 3. Host 506 may include a processor 505, a memory 504, and a storage interface 503. Processor 505, memory 504, and storage interface 503 may have structures and provide functionalities like those of processor 305, memory 354, and storage interface 303 of FIG. 3, respectively, and the similar description will not be repeated herein.

In some implementations, memory system 501 can be a computational storage system that provides computing services and data storage services to host 506. For example, memory system 501 may function as a data storage system for data storage and a computing system configured to execute programs that are either device-defined programs or downloadable programs downloaded from host 506. The device-defined programs can be programs predefined by a manufacturer of memory system 501 and stored in memory system 501. In some implementations, memory system 501 may be implemented in a data center or a server. In some implementations, memory system 501 may be part of an AI training apparatus or part of a cloud computational storage system.

In some implementations, host 506 and memory system 501 can be connected through various interfaces and communicate with one another in accordance with the PCIe/NVMe protocols. For example, host 506 and memory system 501 can be connected via a network link, e.g., based on the NV Me-OF protocol. In another example, host 506 and memory system 501 can be connected through the Compute Express Link (CXL) interface. Memory system 501 may be controlled by host 506 through the CXL interface. The CXL interface can include CXL.io, CXL.cache, and CXL.mem. Memory system 501 can be configured to follow the NVMe computational storage protocol. Host 506 can offload computational programs to memory system 501 such that the programs are executed in memory system 501. Examples of the programs may include, but are not limited to, an encryption program, a decryption program, a compression program, an image recognition program, a filtering program, an AI program, etc.

FIG. 6A illustrates a block diagram of a memory system 600, according to some aspects of the present disclosure. Memory system 600 may be an example of memory system 102 of FIG. 1, memory system 301 of FIG. 3, or memory system 501 of FIG. 5A or 5B. Memory system 600 may include a controller 602, a compute engine 604, a first memory device 606, and a second memory device 608.

Controller 602 can be an example of memory controller 106 of FIG. 1 or memory controller 300 of FIG. 3. In some implementations, controller 602 may be configured to receive commands from a host 601 (shown in FIG. 6B) that is coupled to memory system 600, and parse the commands to control operations of compute engine 604, first memory device 606, and/or second memory device 608. In some implementations, controller 602 may be configured to retrieve data from at least one of first memory device 606 or second memory device 608, and return the data to host 601. In some implementations, controller 602 may be configured to receive data from host 601, and store the data in at least one of first memory device 606 or second memory device 608. In some implementations, controller 602 may be configured to retrieve data from first memory device 606 and store the data in second memory device 608, and vice versa. In some implementations, memory system 600 can use the NVMe protocol as the storage protocol, and controller 602 can include an NVMe controller.

Compute engine 604 can include one or more computing resources capable of providing a computing service. For example, compute engine 604 may include one or more of a CPU, an FPGA, a GPU, an ASIC, etc. Compute engine 604 can be part of controller 602 or can be separate from controller 602, which is not limited herein. Compute engine 604 can be configured to execute programs. In a first example, a program executed by compute engine 604 can be a program downloaded from host 601. Specifically, controller 602 may receive and parse a program-download command from host 601, and download a program from host 601 responsive to the program-download command. The downloaded program may be stored in a memory of controller 602 or in a memory of compute engine 604. In a second example, a program executed by compute engine 604 can be a device-defined program that is pre-stored in memory system 600 (e.g., not downloaded from host 601). In either example, controller 602 may be configured to receive a program-execution command from host 601, and parse the program-execution command to instruct compute engine 604 to execute the program.

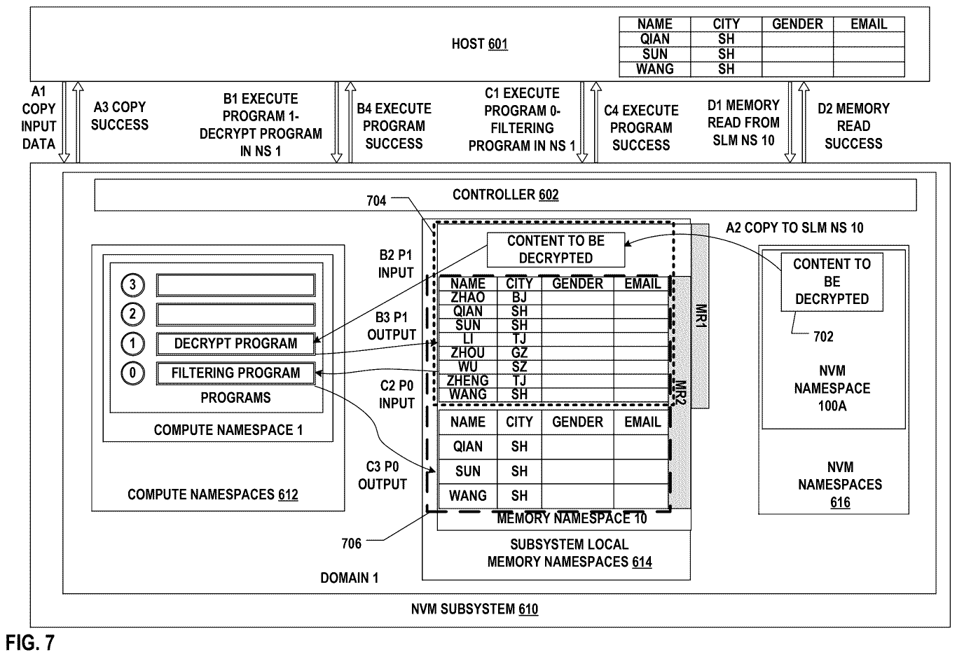

First memory device 606 may include a volatile memory device such as a RAM, a DRAM, a SRAM, a SDRAM, or a DDR SDRAM. In some implementations, first memory device 606 may include (i) a first storage area configured for storing input data and/or output data of a first program executed by compute engine 604 and/or (ii) a second storage area configured for storing input data and output data of a second program executed by compute engine 604. In some implementations, the first storage area may at least partially overlap with the second storage area when the first and second programs share part of the data, as described below in more detail with reference to FIG. 7. Alternatively, the first storage area is not overlapped with the second storage area.

Second memory device 608 may include a non-volatile memory device including, but not limited to, a flash memory (e.g., a NAND flash memory), a phase change memory, a resistive memory, a magnetoresistive memory, a ferroelectric memory, or a polymer memory. Second memory device 608 can be used to store input data and/or output data associated with program execution.

First memory device 606 is accessible by compute engine 604, whereas second memory device 608 is not accessible by compute engine 604. That is, compute engine 604 may be able to access first memory device 606 but cannot access second memory device 608. For example, second memory device 608 may store input data of a program. To begin the execution of the program, the input data may be copied from second memory device 608 to first memory device 606, such that compute engine 604 can access first memory device 606 to retrieve the input data. During the execution of the program or after the program is executed, compute engine 604 can store output data of the program in first memory device 606. Then, the output data can be copied from first memory device 606 to second memory device 608. Controller 602 may access second memory device 608 to retrieve the output data and provide the output data to host 601. Alternatively, the output data may not be copied to second memory device 608. Controller 602 may access first memory device 606 to retrieve the output data and provide the output data to host 601.

FIG. 6B illustrates an example computational storage architecture 650 including various types of namespaces, according to some aspects of the present disclosure. Without loss of generality, computational storage architecture 650 is described with reference to FIG. 6A. Computational storage architecture 650 may include host 601 and a NVM subsystem 610 coupled to host 601, where NVM subsystem 610 may be implemented by memory system 600 (e.g., NVM subsystem 610 may be implemented by an SSD).

NVM subsystem 610 may include one or more compute namespaces 612 (e.g., compute namespace 1, compute namespace 2), one or more subsystem local memory namespaces 614 (e.g., memory namespace 10, memory namespace 11), and one or more NVM namespaces 616 (e.g., NVM namespace 100A, NVM namespace 101A) .

Compute namespace 612 may be implemented by compute engine 604, and one or more programs can be executed in compute namespace 612. For example, compute namespace 612 can be implemented by a CPU or an FPGA. In some implementations, one or more programs can be stored in one or more program slots (e.g., program slots 0, 1, 2, 3) of compute namespace 612, respectively. The one or more program slots can be formed in compute engine 604. In some implementations, a plurality of programs may be stored in a plurality of program slots of a compute namespace 612, and may be executed simultaneously (or one by one) in compute namespace 612. In some implementations, a plurality of programs may be stored in a plurality of program slots of a plurality of compute namespaces 612, respectively, and may be executed simultaneously (or one by one) in the plurality of compute namespaces 612, respectively. When executing a program in compute namespace 612, compute engine 604 can access subsystem local memory namespace 614 to retrieve data from subsystem local memory namespace 614 or to output data to subsystem local memory namespace 614.

Subsystem local memory namespace 614 may be implemented by first memory device 606 (e.g., a RAM) . In some implementations, at least one of an internal RAM of compute engine 604, a common RAM in memory system 600, or an internal RAM of controller 602 can be used to implement subsystem local memory namespace 614. In some implementations, input data and/or output data of a program which is executed in compute namespace 612 can be stored in subsystem local memory namespace 614, and controller 602 may retrieve the input data and/or output data from subsystem local memory namespace 614 responsive to a read request from host 601.

In some implementations, subsystem local memory namespace 614 can be accessed by controller 602. For example, controller 602 may include a first control unit (e.g., a cache controller) configured to control subsystem local memory namespace 614. The first control unit can be an internal component integrated into controller 602. Alternatively, the first control unit can be configured as a component separate from controller 602.

NVM namespace 616 may be implemented by second memory device 608. In some implementations, controller 602 may be configured to perform a variety of operations for controlling a NVM namespace 616. The operations may include, but are not limited to, the following: an address mapping operation, a wear leveling operation, and/or a garbage collection operation. The address mapping operation can include mapping a logical address managed by host 601 or controller 602 to a physical address in NVM namespace 616. Wear leveling can be an operation that equalizes the usage frequency of the memory blocks included in NVM namespace 616. The garbage collection operation can be an operation that copies valid data from a source block of NVM namespace 616 to a target block of NVM namespace 616, and then erases the source block to ensure that the source block becomes an empty block.

In some implementations, NVM namespace 616 can be accessed by controller 602. For example, controller 602 may include a second control unit (e.g., a flash controller) configured to control NVM namespace 616. The second control unit can be an internal component integrated into controller 602. Alternatively, the second control unit can be configured as a component separate from controller 602.

In some implementations, controller 602 may copy data (e.g., input data of a program) stored in NVM namespace 616 to subsystem local memory namespace 614, and may copy data (e.g., output data of the program) stored in subsystem local memory namespace 614 to NVM namespace 616. In other words, controller 602 can control the data storage and/or data transfer between subsystem local memory namespace 614 and NVM namespace 616 according to the actual program execution needs of compute namespace 612.

Consistent with some aspects of the present disclosure, a program that is executed in compute namespace 612 can be a device-defined program or a downloadable program downloaded from host 601. For example, if the program is a downloadable program, controller 602 may download the program from host 601 responsive to receiving a program-download command from host 601. Controller 602 may store the downloadable program in a program slot of compute namespace 612 (e.g., Program 0 being downloaded from host 601 and stored in program slot 0 of compute namespace 1, as shown in FIG. 6B). Alternatively, controller 602 may store the downloadable program in a memory of controller 602 and then load the downloadable program into a program slot of compute namespace 612 upon execution of the program. In another example, if the program is a device-defined program, the program can be pre-stored in memory system 600 and loaded to a program slot of compute namespace 612 upon execution of the program.

In either case, upon receiving a program-execution command from host 601 that instructs to execute the program, controller 602 may parse the program-execution command to cause compute engine 604 to execute the program in compute namespace 612. For example, to begin the execution of the program, controller 602 may copy input data of the program from NVM namespace 616 to subsystem local memory namespace 614, such that compute engine 604 can access subsystem local memory namespace 614 to retrieve the input data for the program execution. After the program is executed, compute engine 604 may store output data in subsystem local memory namespace 614. Then, controller 602 may copy the output data from subsystem local memory namespace 614 to NVM namespace 616. Then, controller 602 may access NV M namespace 616 to retrieve the output data and provide the output data to host 601. Alternatively, the output data may not be copied from subsystem local memory namespace 614 to NVM namespace 616. Controller 602 may access subsystem local memory namespace 614 to retrieve the output data and provide the output data to host 601.

FIG. 7 illustrates an example program execution process under the computational storage architecture of FIG. 6B, according to some aspects of the present disclosure. FIG. 7 is described with reference to FIGS. 6A and 6B. To begin the program execution process, two programs are loaded into compute namespaces 612. For example, controller 602 or compute engine 604 may load a filtering program and a decrypt program into program slots 0 and 1 of compute namespace 1, respectively. The filtering program and the decrypt program may be identified with program indices “P0” and “P1,” respectively.

In step A1, host 601 may send a copy command to copy input data from NVM namespaces 616 to subsystem local memory namespaces 614. Responsive to receiving the copy command, in step A2, controller 602 may copy input data 702 (e.g., content to be decrypted) stored in NVM namespace 100A of NVM namespaces 616 to a first address scope 704 of memory namespace 10 within subsystem local memory namespaces 614. First address scope 704 of memory namespace 10 can be indicated by a first memory range set (MRS1), such that compute engine 604 can access first address scope 704 indicated by the first memory range set MRS1 during the execution of the decrypt program (P1) in compute namespace 1 (e.g., the input data and output data of the decrypt program (P1) can be stored in first address scope 704). In step A3, controller 602 may return a “copy success” response to host 601 after the input data is successfully copied from NVM namespace 100A to memory namespace 10.

In some implementations, the input data is not copied from NVM namespaces 616 to subsystem local memory namespaces 614. Instead, host 601 may send the input data to controller 602, such that controller 602 may store the input data in first address scope 704 of memory namespace 10. In some implementations, host 601 may send the input data to controller 602, such that controller 602 may store the input data in NVM namespace 100A. Then, upon receiving the copy command from host 601, controller 602 may copy the input data stored in NVM namespace 100A to first address scope 704 of memory namespace 10.

Next, in step B1, host 601 may send a program-execution command “execute program 1—decrypt program—in compute namespace 1” to controller 602. Controller 602 may parse the program-execution program, to cause compute engine 604 to retrieve the input data of the decrypt program (P1) from memory namespace 10 in step B2. Compute engine 604 may execute the decrypt program (P1) using the input data in compute namespace 1, and, in step B3, store output data of the decrypt program (P1) in first address scope 704 indicated by the first memory range set MRS1. In step B4, controller 602 may return a response to host 601 indicating that the decrypt program (P1) is successfully executed (“execute program success”).

Subsequently, in step C1, host 601 may send another program-execution command “execute program 0-filtering program-in compute namespace 1” to controller 602. Controller 602 may parse the program-execution program, to cause compute engine 604 to retrieve input data of the filtering program (P0) from memory namespace 10 in step C2. For example, compute engine 604 may retrieve the input data of the filtering program (P0) from a second address scope 706 of memory namespace 10. Second address scope 706 of memory namespace 10 can be indicated by a second memory range set MRS2, such that compute engine 604 can access second address scope 706 indicated by the second memory range set MRS2 during the execution of the filtering program (P0) in compute namespace 1 (e.g., the input data and output data of the filtering program (P0) can be stored in second address scope 706 of memory namespace 10).

In some implementations, first and second address scopes 704 and 706 of memory namespace 10 may overlap with one another. The output data of the decrypt program (P1) is stored in an overlapping portion of first and second address scopes 704 and 706, such that the output data of the decrypt program (P1) can be used as the input data of the filtering program (P0). For example, subsystem local memory spaces 614 is implemented by first memory device 606 of FIG. 6A. First address scope 704 may specify a first storage area in first memory device 606, and second address scope 706 may specify a second storage area in first memory device 606, where the output data of the decrypt program (P1) is stored in an overlapping portion of the first and second storage areas of first memory device 606.

Compute engine 604 may retrieve the input data of the filtering program (P0) from memory namespace 10, and execute the filtering program (P0) using the input data of the filtering program (P0) in compute namespace 1. In step C3, compute engine 604 may store output data of the filtering program (P0) in second address scope 706 indicated by the second memory range set MRS2. In step C4, controller 602 may return a response to host 601 indicating that the filtering program (P0) is successfully executed (“execute program success”).

In step D1, host 601 may send a read command “memory read from SLM NS 10” to controller 602, instructing controller 602 to return the output data of the filtering program (P0) from memory namespace 10. Controller 602 may parse the read command to retrieve the output data of the filtering program (P0) from memory namespace 10, and provide the output data to host 601. In step D2, controller 602 may return a response (“memory read success”) to host 601, indicating that the output data of the filtering program (P0) is returned to host 601 successfully.

In some implementations, controller 602 may copy the output data of the filtering program (P0) stored in memory namespace 10 to NVM namespace 100A. Upon receiving a read command to read the output data from host 601, controller 602 may retrieve the output data of the filtering program (P0) from NVM namespace 100A, and provide the output data to host 601.

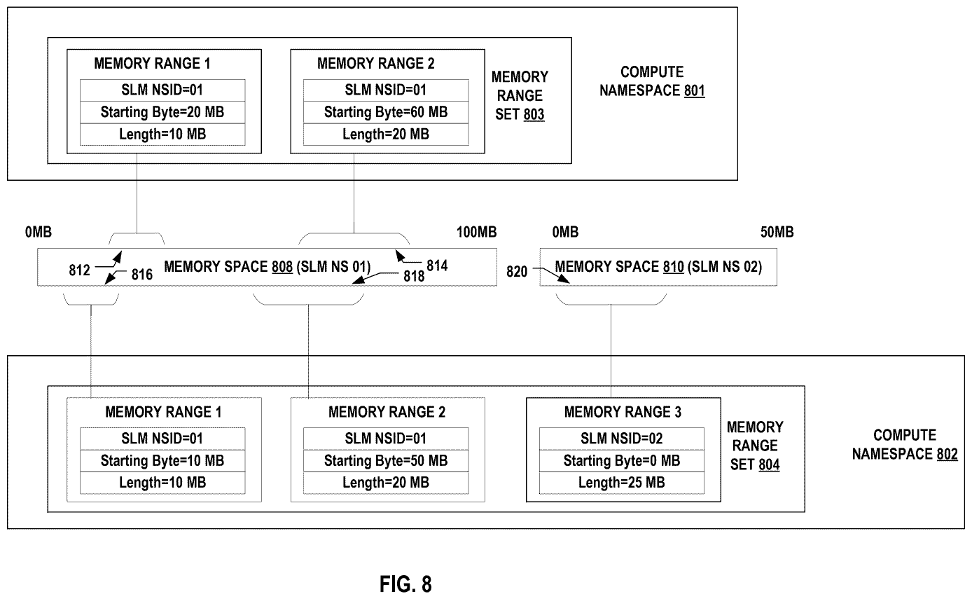

FIG. 8 illustrates example memory range sets, according to some aspects of the present disclosure. In some implementations, responsive to a configuration command from a host (e.g., host 601), a storage area in a first memory device (e.g., first memory device 606) can be configured for storing input data and/or output data of a program. For example, a memory namespace can be implemented by the first memory device. An address scope of the memory namespace for storing the input data and/or output data of the program can be indicated by a memory range (MR). The address scope may be used to specify the storage area in the first memory device.

The memory range MR can include an identity of the memory namespace in subsystem local memory namespaces (SLM NS ID), a starting byte (e.g., an offset) and a data length of the address scope in the memory namespace, such that the memory range may determine the address scope of the memory namespace that is accessible by a compute engine (e.g., compute engine 604) for the execution of the program. A collection of memory ranges (e.g., one or more memory ranges) may form a memory range set (MRS) for the execution of the program. The memory range set MRS is created in the compute namespace and is specific to that compute namespace. During execution of the program in the compute namespace, the compute engine can access address scopes of the memory namespace indicated by the memory range set MRS, and is prohibited from accessing other address scopes of the memory namespace or other memory namespaces not included in the memory range set MRS.

For example, with reference to FIG. 8, a memory range set 803 is created for a compute namespace 801. Memory range set 803 may include a memory range 1 and a memory range 2. The memory range 1 includes an identity of a memory namespace 808 (SLM NSID=01), a starting byte of 20 MB, and a length of 10 MB of an address scope 812 in memory namespace 808. The memory range 2 includes the identity of memory namespace 808 (SLM NSID=01), a starting byte of 60 MB, and a length of 20 MB of an address scope 814 in memory namespace 808.

A memory range set 804 is created for a compute namespace 802. Memory range set 804 may include a memory range 1, a memory range 2, and a memory range 3. The memory range 1 includes an identity of memory namespace 808 (SLM NSID=01), a starting byte of 10 MB, and a length of 10 MB of an address scope 816 in memory namespace 808. The memory range 2 includes the identity of memory namespace 808 (SLM NSID=01), a starting byte of 50 MB, and a length of 20 MB of an address scope 818 in memory namespace 808. The memory range 3 includes an identity of a memory namespace 810 (SLM NSID=02), a starting byte of 0 MB, and a length of 25 MB of an address scope 820 in memory namespace 810.

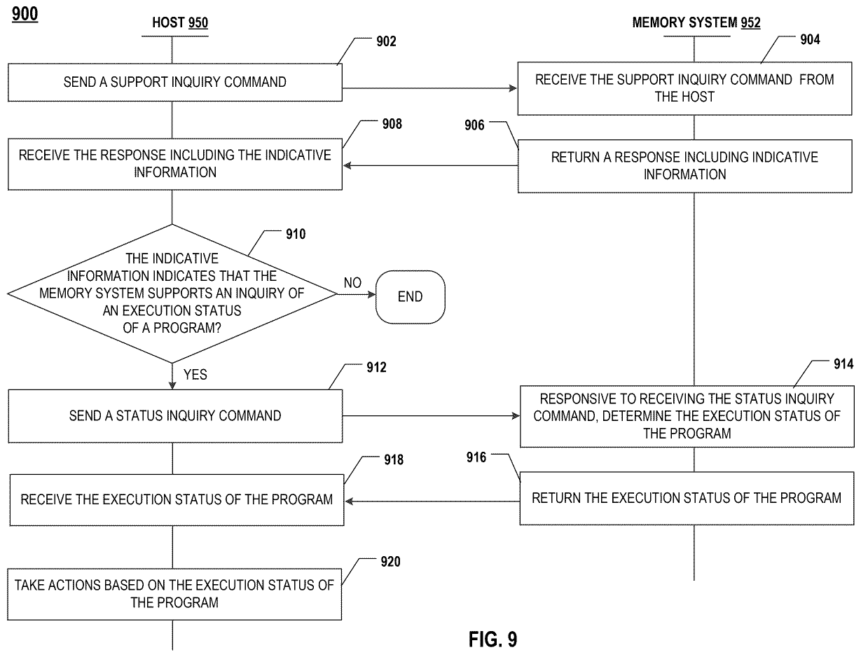

FIG. 9 illustrates a process 900 of operating an electronic system, according to some aspects of the present disclosure. The electronic system can be an example of any electronic system disclosed herein, such as system 100 of FIG. 1, system 399 of FIG. 3, system 500 of FIG. 5A, or system 550 of FIG. 5B. The electronic system may include a host 950 and a memory system 952 coupled to host 950. Host 950 can be any host disclosed herein, such as host 108 of FIG. 1, host 306 of FIG. 3, host 506 of FIG. 5A or 5B, or host 601 of FIG. 6B. Memory system 952 can be any memory system disclosed herein, such as memory system 102 of FIG. 1, memory system 301 of FIG. 3, memory system 501 of FIG. 5A or 5B, or memory system 600 of FIG. 6A. It is understood that the operations shown in process 900 may not be exhaustive and that other operations can be performed as well before, after, or between any of the illustrated operations. Further, some of the operations may be performed simultaneously, or in a different order than shown in FIG. 9.

In some implementations, memory system 952 may include a controller (e.g., controller 602 or any other controller disclosed herein) and a compute engine (e.g., compute engine 604). A program (e.g., a device-defined program or a downloadable program) can be executed in a compute namespace implemented by the compute engine. The controller may receive a program-execution command from the host and parse the program-execution command that instructs to execute the program in memory system 952. The compute engine may execute the program responsive to the program-execution command. For example, the compute engine may execute the program in the compute namespace responsive to the program-execution command.

In some implementations, the memory system further includes a first memory device (e.g., first memory device 606) accessible by the compute engine for the execution of the program and a second memory device (e.g., second memory device 608). The controller may copy input data of the program from the second memory device to the first memory device. The compute engine may access the first memory device to retrieve the input data of the program from the first memory device and to store output data of the program in the first memory device. For example, a memory namespace can be implemented by the first memory device, and an NVM namespace can be implemented by the second memory device. The controller may copy input data of the program from the NVM namespace to an address scope of the memory namespace indicated by a memory range set, such that the compute engine may access the address scope of the memory namespace to retrieve the input data of the program. The compute engine may store the output data of the program in the address scope of the memory namespace indicated by the memory range set.

Process 900 may begin with operation 902, in which host 950 (e.g., a processor of host 950) may send a support inquiry command to memory system 952. The support inquiry command can be configured to inquire whether memory system 952 supports an inquiry of an execution status of the program. That is, host 950 may send the support inquiry command to memory system 952 in order to learn whether memory system 952 supports the inquiry of the execution status of the program.

Process 900 may proceed to operation 904, in which memory system 952 (e.g., the controller of memory system 952) may receive the support inquiry command from host 950.

Process 900 may proceed to operation 906, in which memory system 952 (e.g., the controller of memory system 952) may return a response including indicative information to host 950 responsive to the support inquiry command. The indicative information may indicate whether memory system 952 supports the inquiry of the execution status of the program.

In some implementations, the support inquiry command may include an identify command (with compute namespace (CNS)=05h, command set identifier (CSI)=04h). The response returned from memory system 952 to host 950 may include an I/O command set specific identify namespace data structure for a computational programs command set. The indicative information can be a field of the I/O command set specific identify namespace data structure for the computational programs command set.

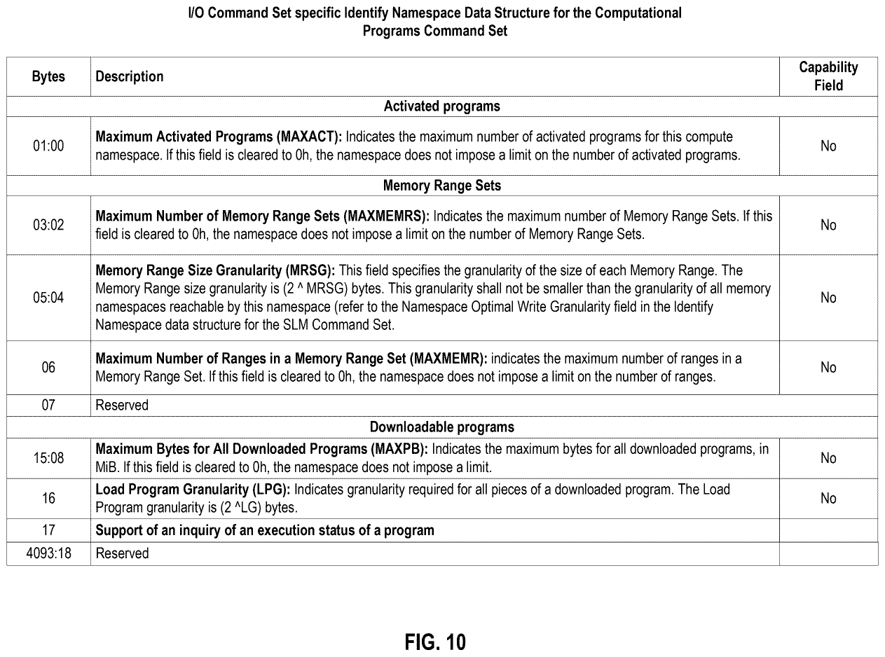

FIG. 10 shows an example structure of the I/O command set specific identify namespace data structure for the computational programs command set. In the 17^{th} byte of the data structure shown in FIG. 10, a field “Support of an inquiry of an execution status of a program” (e.g., an example of the indicative information) is included. The field “Support of an inquiry of an execution status of a program” can be a one-bit field in the 17^{th} byte of the data structure shown in FIG. 10. For example, if the field “Support of an inquiry of an execution status of a program” has a value of “1” (e.g., the indicative information having a value of “1”), then it is determined that memory system 952 supports the inquiry of the execution status of the program (e.g., memory system 952 provides the functionality that allows host 950 to inquire the execution status of the program when the program is executed in the compute namespace). Alternatively, if the field “Support of an inquiry of an execution status of a program” has a value of “0” (e.g., the indicative information having a value of “0”), then it is determined that memory system 952 does not support the inquiry of the execution status of the program (e.g., host 950 is not allowed to inquire the execution status of the program when the program is executed in the compute namespace).

By way of examples, the identify command and the I/O command set specific identify namespace data structure for the computational programs command set can be used to learn whether memory system 952 supports the inquiry of the execution status of the program. It is contemplated that other commands and other data structures can also be used to learn whether memory system 952 supports the inquiry of the execution status of the program, which is not limited herein.

Referring to FIG. 9, process 900 may proceed to operation 908, in which host 950 (e.g., the processor of host 950) may receive the response including the indicative information from memory system 952.

Process 900 may proceed to operation 910, in which host 950 (e.g., the processor of host 950) determines whether the indicative information indicates that memory system 952 supports the inquiry of the execution status of the program. Responsive to the indicative information indicating that memory system 952 supports the inquiry of the execution status of the program, process 900 proceeds to operation 912. Otherwise, process 900 ends.

In operation 912, host 950 may send a status inquiry command to memory system 952, where the status inquiry command may be configured to inquire the execution status of the program executed by memory system 952. For example, the status inquiry command may be configured to inquire the execution status of the program executed in the compute namespace.

Process 900 may proceed to operation 914, in which memory system 952 (e.g., the compute engine of memory system 952) may determine the execution status of the program responsive to receiving the status inquiry command. Process 900 may proceed to operation 916, in which memory system 952 (e.g., the controller of memory system 952) may return the execution status of the program to host 950.

In some implementations, the status inquiry command may include at least one of (i) an identity of the compute namespace where the program is executed or (ii) a program index associated with the program. For example, assuming that the program is the filtering program shown in FIG. 7. The status inquiry command may include an identity of compute namespace 1 where the filtering program is executed, as well as the program index P0 of the filtering program. In another example, the status inquiry command can be a Get Program Execution Progress command that includes the program index of the program.

In some implementations, the status inquiry command may include at least one of (i) an identity of the compute namespace where the program is executed, (ii) a program index associated with the program, or (iii) an operation type field indicating a type of an operation of the command. For example, the operation type field may indicate that the type of the operation of the command is to query an execution progress of the program. It is contemplated that the type of the operation of the command can also be expanded to include other operations (e.g., not limited to the inquiry of the execution progress of the program), which is not limited herein. In another example, the status inquiry command can be a Get Program Execution Status command that includes (i) the program index of the program and (ii) the operation type field indicating that the type of the operation of the command is to query an execution progress of the program.

In some implementations, the status inquiry command may include a log page identifier (ID) used to identify a log page, where the execution status of the program is recorded in the log page. Memory system 952 (e.g., the controller of memory system 952) may return the log page including the execution status of the program to host 950. For example, memory system 952 may create a log page that records execution statuses of programs executed in one or more compute namespaces. The status inquiry command can be a Get Log Page command including a log page ID of the log page. Responsive to receiving the Get Log Page command, memory system 952 may return the log page identified by the log page ID to host 950. The returned log page may include the execution status of the program. In some examples, the returned log page further includes execution statuses of other programs executed in the one or more compute namespaces.

In some implementations, the execution status of the program may include an execution progress of the program. The execution progress of the program may include at least one of a remaining execution time of the program or a percentage of the execution progress of the program. The percentage of the execution progress of the program can be a percentage of the program that is completed, such as 30%, 50%, etc. This percentage can be indicated using a byte (e.g., if the byte has a value of 50, then the percentage of the execution progress of the program is 50%). The remaining execution time of the program may be indicated using one or more bytes. For example, the remaining execution time of the program may be indicated using four bytes having a unit of millisecond (ms), having a value range from 1 ms to 1193 hours. If the remaining execution time of the program exceeds a predetermined threshold (e.g., more than 1193 hours) or cannot be determined, then the four bytes may have a value of 0xFFFFFFFF.

Memory system 952 may determine the execution progress of the program based at least in part on a type of the program, whether the program is currently being executed or not, or computing resources configured in memory system 952. The computing resources configured in memory system 952 may include available computing resources of memory system 952 that can be used to execute the program. For example, if the program is currently being executed, memory system 952 may determine the execution progress of the program to be 30% and the remaining execution time of the program to be 30 minutes based on the type of the program and the available computing resources of the compute engine that can be used to execute the program. In another example, if the program is not being executed and memory system 952 has obtained or stored an execution outcome (e.g., execution result) of the program, memory system 952 may determine the execution progress of the program to be 100%.

In some implementations, the execution status of the program may include an abnormal execution status indicating that the program is hanging. For example, if the program is not being executed (e.g., the execution of the program is terminated) and there is no execution outcome (e.g., no execution result) of the program stored in memory system 952, memory system 952 may determine that the program is hanging. Memory system 952 may fail to provide the execution progress of the program to host 950. Memory system 952 may provide the abnormal execution status to host 950.

Process 900 may proceed to operation 918, in which host 950 may receive the execution status of the program. Process 900 may proceed to operation 920, in which host 950 may take actions based on the execution status of the program. For example, responsive to the execution status of the program including an execution progress of the program, host 950 may report the execution progress of the program to a user operating on host 950. In another example, responsive to the execution status of the program including an abnormal execution status of the program, host 950 may abort the execution of the program and report the abnormal execution status of the program to the user.

Consistent with some aspects of the present disclosure, one or more programs may be executed in a compute namespace simultaneously. Host 950 may send a status inquiry command to memory system 952 to inquire an execution status of at least one of the one or more programs. For example, the status inquiry command may include an identity of the compute namespace and one or more program indices of the one or more programs. Responsive to receiving the status inquiry command, memory system 952 may determine the one or more execution statuses of the one or more programs and return a response that includes the one or more execution statuses of the one or more programs to host 950.

In another example, the status inquiry command can be a Get Log Page command including a log page ID of a log page, where the log page is used by memory system 952 to record the one or more execution statuses of the one or more programs in the compute namespace. Responsive to receiving the Get Log Page command, memory system 952 may return the log page identified by the log page ID to host 950, where the log page includes the one or more execution statuses of the one or more programs.

In still another example, the status inquiry command may include an identity of the compute namespace and a program index of a first program from the programs. Responsive to receiving the status inquiry command, memory system 952 may determine an execution status of the first program and return a response that includes the execution status of the first program to host 950. Execution statuses of the other programs are not included in the response because the program indices of the other programs are not included in the status inquiry command.

Consistent with some aspects of the present disclosure, one or more programs may be simultaneously executed in one or more compute namespaces, respectively. Host 950 may send a status inquiry command to memory system 952 to inquire one or more execution statuses of the one or more programs. For example, the status inquiry command may include one or more identities of the one or more compute namespaces and one or more program indices of the one or more programs. Responsive to receiving the status inquiry command, memory system 952 may determine the one or more execution statuses of the one or more programs in the one or more compute namespaces, respectively, and return a response that includes the one or more execution statuses of the one or more programs to host 950. In another example, the status inquiry command can be a Get Log Page command including a log page ID of a log page, where the log page is used by memory system 952 to record the one or more execution statuses of the one or more programs in the one or more compute namespaces, respectively. Responsive to receiving the Get Log Page command, memory system 952 may return the log page identified by the log page ID to host 950, where the log page includes the one or more execution statuses of the one or more programs in the one or more compute namespaces, respectively.

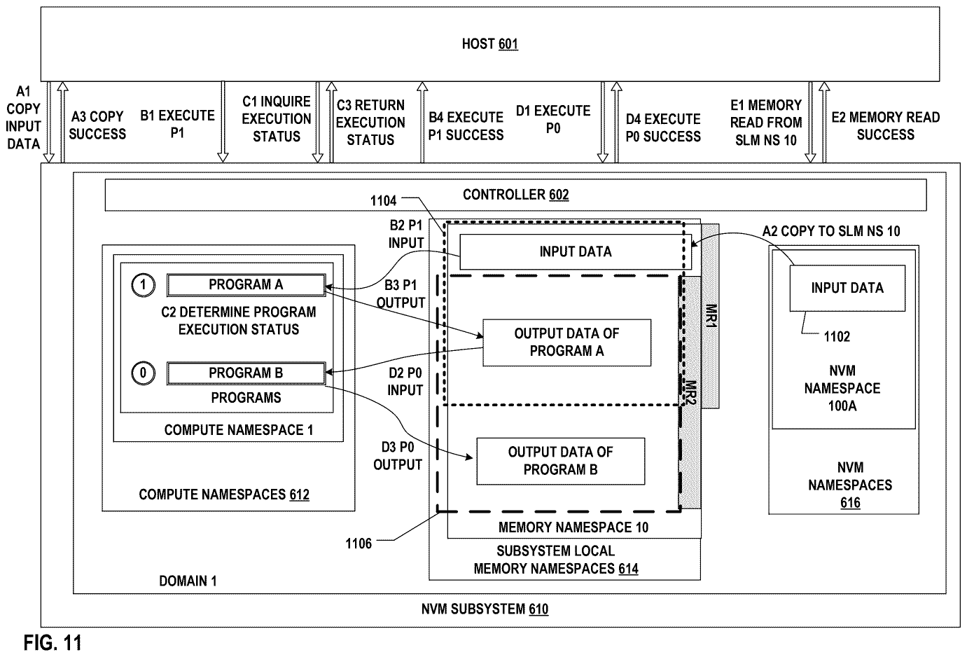

FIG. 11 illustrates another example program execution process under the computational storage architecture of FIG. 6B, according to some aspects of the present disclosure. FIG. 11 is described with reference to FIGS. 6A and 6B. To begin the program execution process, two programs are loaded into compute namespaces 612. For example, controller 602 or compute engine 604 may load a program B and a program A into program slots 0 and 1 of compute namespace 1, respectively. Program B and program A may be identified with program indices “P0” and “P1,” respectively, where “P” represents program, and “0” and “1” represent the corresponding program slots respectively.

In step A1, host 601 may send a copy command to copy input data 1102 from NVM namespaces 616 to subsystem local memory namespaces 614. Responsive to receiving the copy command, in step A2, controller 602 may copy input data 1102 stored in NVM namespace 100A of NVM namespaces 616 to a first address scope 1104 of memory namespace 10 within subsystem local memory namespaces 614. First address scope 1104 of memory namespace 10 can be indicated by a first memory range set (MRS1), such that compute engine 604 can access first address scope 1104 indicated by the first memory range set MRS1 during the execution of program A (P1) (e.g., the input data and output data of program A (P1) can be stored in first address scope 1104). In step A3, controller 602 may return a “copy success” response to host 601 after the input data is successfully copied from NVM namespace 100A to memory namespace 10.

Next, in step B1, host 601 may send a program-execution command “execute program 1—program A—in compute namespace 1” to controller 602. Controller 602 may parse the program-execution command, to cause compute engine 604 to retrieve the input data of program A (P1) from memory namespace 10 in step B2. Compute engine 604 may execute program A (P1) using the input data in compute namespace 1, and, in step B 3, store output data of program A (P1) in first address scope 1104 of memory namespace 10 indicated by the first memory range set MRS1.

In step C1, host 601 may send a status inquiry command to inquire an execution status of program A. Controller 602 may receive and parse the status inquiry command, to cause compute engine 604 to determine the execution status of program A in step C2. For example, compute engine 604 may determine that a program execution progress of program A is 70%. Compute engine 604 may send the execution status of program A to controller 602, causing controller 602 to send the execution status of the program A to host 601 in step C3.

When the execution of program A in compute namespace 1 is completed, controller 602 may return a response to host 601 in step B4, where the response indicates that program A (P1) is successfully executed (“execute program 1—program A—success”).

Subsequently, in step D1, host 601 may send another program-execution command “execute program 0—program B—in compute namespace 1” to controller 602. Controller 602 may parse the program-execution command, to cause compute engine 604 to retrieve input data of the program B (P0) from memory namespace 10 in step D2. For example, compute engine 604 may retrieve the input data of program B (P0) from a second address scope 1106 of memory namespace 10. Second address scope 1106 of memory namespace 10 can be indicated by a second memory range set MRS2, such that compute engine 604 can access second address scope 1106 indicated by the second memory range set MRS2 during the execution of program B (P0) (e.g., the input data and output data of program B (P0) can be stored in second address scope 1106 of memory namespace 10).

In some implementations, first and second address scopes 1104 and 1106 of memory namespace 10 may overlap with one another. The output data of program A (P1) is stored in an overlapping portion of first and second address scopes 1104 and 1106, such that the output data of program A (P1) can be used as the input data of program B (P0). For example, subsystem local memory spaces 614 is implemented by first memory device 606 of FIG. 6A. First address scope 1104 may be used to specify a first storage area in first memory device 606, and second address scope 1106 may be used to specify a second storage area in first memory device 606. The output data of program A (P1) is stored in an overlapping portion of the first and second storage areas of first memory device 606.

Compute engine 604 may access the input data of program B (P0) from memory namespace 10, and execute program B (P0) using the input data of program B (P0) in compute namespace 1. In step D3, compute engine 604 may store output data of program B (P0) in second address scope 1106 indicated by the second memory range set MRS2. In step D4, controller 602 may return a response to host 601, indicating that program B (P0) is successfully executed (“execute program 0—program B—success”).

In step E1, host 601 may send a read command “memory read from SLM NS 10” to controller 602, instructing controller 602 to return the output data of program B (P0). Controller 602 may parse the read command to retrieve the output data of program B (P0) from memory namespace 10, and provide the output data to host 601. In step E2, controller 602 may return a response (“memory read success”) to host 601, indicating that the output data of program B (P0) is returned to host 601 successfully.

In some implementations, controller 602 may copy the output data of program B (P0) stored in memory namespace 10 to NVM namespace 100A. Upon receiving a read command to read the output data from host 601, controller 602 may retrieve the output data of program B (P0) from NVM namespace 100A, and provide the output data to host 601.

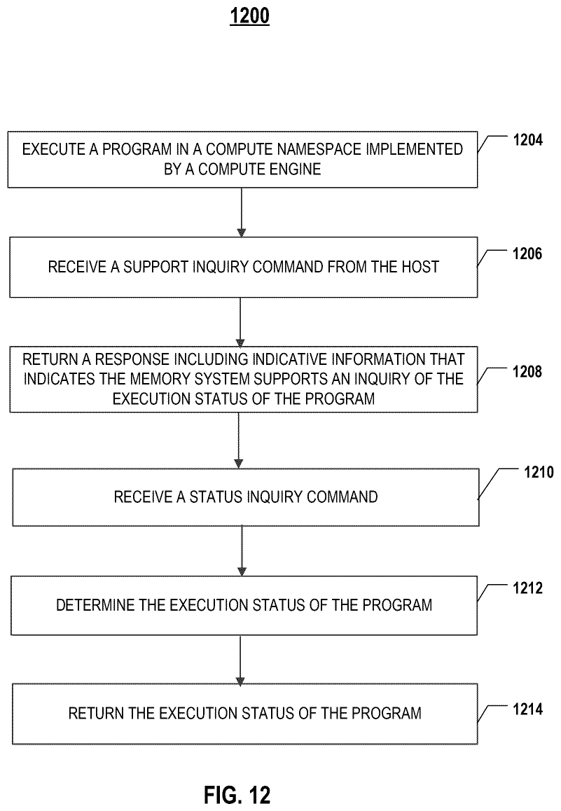

FIG. 12 illustrates a flowchart of a method 1200 for operating a memory system, according to some aspects of the present disclosure. The memory system may be any suitable memory system disclosed herein, such as memory system 102 of FIG. 1, memory system 301 of FIG. 3, memory system 500 of FIG. 5A or 5B, memory system 600 of FIG. 6A, or memory system 952 of FIG. 9. Method 1200 may be implemented by components of the memory system (e.g., controller 602 and compute engine 604 of memory system 600). It is understood that the operations shown in method 1200 may not be exhaustive and that other operations can be performed as well before, after, or between any of the illustrated operations. Further, some of the operations may be performed simultaneously, or in a different order than shown in FIG. 12.

Referring to FIG. 12, method 1200 starts at operation 1204, in which a program is executed in a compute namespace implemented by a compute engine of the memory system. For example, the program can be a downloadable program downloaded from a host coupled to the memory system. In another example, the program can be a device-defined program. For example, the memory system may include a controller and a compute engine. The controller is configured to receive and parse a second command (e.g., a program-execution command) that instructs to execute the program, and the compute engine is configured to execute the program responsive to the second command.

Method 1200 proceeds to operation 1206, as illustrated in FIG. 12, in which a support inquiry command is received from the host. The support inquiry command may be configured to inquire whether the memory system supports an inquiry of an execution status of the program. For example, the host is configured to send a third command (e.g., a support inquiry command) to the memory system, where the third command is configured to inquire whether the memory system supports an inquiry of the execution status of the program.

Method 1200 proceeds to operation 1208, as illustrated in FIG. 12, in which a response corresponding to the support inquiry command is returned to the host. For example, the response includes indicative information indicating that the memory system supports the inquiry of the execution status of the program.

Method 1200 proceeds to operation 1210, as illustrated in FIG. 12, in which a status inquiry command is received from the host. The status inquiry command is configured to inquire the execution status of the program executed by the memory system. For example, the host may send a first command (e.g., a status inquiry command) to a memory system, where the first command is configured to inquire an execution status of a program executed by the memory system.

Method 1200 proceeds to operation 1212, as illustrated in FIG. 12, in which the execution status of the program is determined.

Method 1200 proceeds to operation 1214, as illustrated in FIG. 12, in which the execution status of the program is returned to the host.

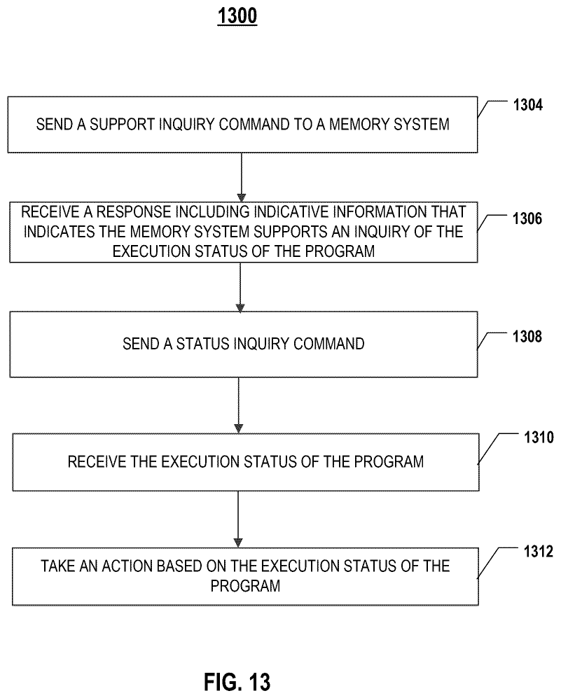

FIG. 13 illustrates a flowchart of a method 1300 performed by a host, according to some aspects of the present disclosure. The host may be any suitable host disclosed herein, such as host 108 of FIG. 1, host 306 of FIG. 3, host 506 of FIG. 5A or 5B, or host 601 of FIG. 6B. Method 1300 may be implemented by components of the host (e.g., processor 305 of host 306). It is understood that the operations shown in method 1300 may not be exhaustive and that other operations can be performed as well before, after, or between any of the illustrated operations. Further, some of the operations may be performed simultaneously, or in a different order than shown in FIG. 13.

Referring to FIG. 13, method 1300 starts at operation 1304, in which a support inquiry command is sent to a memory system coupled to the host. The support inquiry command is configured to inquire whether the memory system supports an inquiry of an execution status of the program. For example, the host is configured to send a third command (e.g., a support inquiry command) to the memory system, where the third command is configured to inquire whether the memory system supports an inquiry of the execution status of the program.

Method 1300 proceeds to operation 1306, as illustrated in FIG. 13, in which a response corresponding to the support inquiry command is received. For example, the response includes indicative information indicating that the memory system supports the inquiry of the execution status of the program.

Method 1300 proceeds to operation 1308, as illustrated in FIG. 13, in which a status inquiry command is sent to the memory system. The status inquiry is configured to inquire the execution status of the program executed by the memory system. For example, the host may send a first command (e.g., a status inquiry command) to a memory system, where the first command is configured to inquire an execution status of a program executed by the memory system.

Method 1300 proceeds to operation 1310, as illustrated in FIG. 13, in which the execution status of the program is received from the memory system.

Method 1300 proceeds to operation 1312, as illustrated in FIG. 13, in which an action may be taken based on the execution status of the program.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some implementations, the computer-readable medium may be a disc or a flash drive having the computer instructions stored thereon.

The foregoing description of the specific implementations can be readily modified and/or adapted for various applications. Therefore, such adaptations and modifications are intended to be within the meaning and range of equivalents of the disclosed implementations, based on the teaching and guidance presented herein.

The breadth and scope of the present disclosure should not be limited by any of the above-described exemplary implementations, but should be defined only in accordance with the following claims and their equivalents.

1. An electronic system, comprising:
a host configured to send a first command to a memory system, wherein the first command is configured to inquire an execution status of a program executed by the memory system; and
the memory system coupled to the host and configured to:
responsive to receiving the first command, determine the execution status of the program; and
return the execution status of the program to the host,
wherein the host is configured to send a second command to the memory system, wherein the second command is configured to inquire whether the memory system supports an inquiry of the execution status of the program, and
wherein responsive to receiving the second command, the memory system is configured to return a response comprising indicative information to the host, wherein the indicative information indicates whether the memory system supports the inquiry of the execution status of the program.

2. The electronic system of claim 1, wherein:
the memory system comprises a controller and a compute engine;
the controller is configured to receive and parse a second third command that instructs to execute the program; and
the compute engine is configured to execute the program responsive to the second third command.

3. The electronic system of claim 2, wherein a compute namespace is implemented by the compute engine such that the program is executed in the compute namespace.

4. The electronic system of claim 2, wherein:
the controller is configured to receive the first command from the host;
the compute engine is configured to determine the execution status of the program responsive to the first command; and
the controller is further configured to return the execution status of the program to the host.

5. The electronic system of claim 2, wherein:
the memory system further comprises a first memory device accessible by the compute engine for the execution of the program and a second memory device;
the controller is configured to copy input data of the program from the second memory device to the first memory device; and
the compute engine is configured to access the first memory device to retrieve the input data of the program from the first memory device and to store output data of the program in the first memory device.

6. (canceled)

7. The electronic system of claim 1, wherein responsive to the indicative information indicating that the memory system supports the inquiry of the execution status of the program, the host is configured to send the first command to the memory system.

8. The electronic system of claim 1, wherein:
the second command comprises an identify command;
the response returned from the memory system to the host comprises an input/output (I/O) command set specific identify namespace data structure for a computational programs command set; and
the indicative information includes a field in the I/O command set specific identify namespace data structure for the computational programs command set.

9. The electronic system of claim 1, wherein:
the execution status of the program comprises an execution progress of the program; and
the memory system is configured to determine the execution progress of the program based at least in part on a type of the program, whether the program is being executed, or computing resources configured in the memory system.

10. The electronic system of claim 9, wherein the execution progress of the program comprises at least one of a remaining execution time of the program or a percentage of the execution progress of the program.

11. The electronic system of claim 1, wherein the execution status of the program comprises an abnormal execution status indicating that the program is hanging or the program is not being executed.

12. The electronic system of claim 1, wherein the first command comprises a program index associated with the program.

13. The electronic system of claim 12, wherein the first command further comprises an operation type indicating that a type of an operation of the first command is to query an execution progress of the program.

14. The electronic system of claim 1, wherein:
the first command comprises a log page identifier (ID) used to identify a log page, and the execution status of the program is recorded in the log page; and
the memory system is configured to return the log page comprising the execution status of the program to the host.

15. The electronic system of claim 1, wherein:
responsive to the execution status of the program comprising an execution progress of the program, the host is configured to report the execution progress of the program to a user; or
responsive to the execution status of the program comprising an abnormal execution status of the program, the host is configured to abort the execution of the program.

16. A memory system, comprising:
a controller configured to receive a first command, wherein the first command is configured to inquire an execution status of a program; and
a compute engine configured to execute the program, and determine the execution status of the program responsive to the first command,
wherein the controller is configured to return the execution status of the program to a host,
wherein the controller is further configured to receive a second command from the host, wherein the second command is configured to inquire whether the memory system supports an inquiry of the execution status of the program, and
wherein responsive to receiving the second command, the controller is further configured to return a response comprising indicative information to the host, wherein the indicative information indicates whether the memory system supports the inquiry of the execution status of the program.

17. A method of operating a memory system, comprising:
executing a program in the memory system;
receiving a first command configured to inquire an execution status of the program;
determining the execution status of the program in the memory system responsive to the first command; and
returning the execution status of the program to a host,
wherein the method further comprises:
receiving a second command from the host, wherein the second command is configured to inquire whether the memory system supports an inquiry of the execution status of the program; and
responsive to receiving the second command, returning a response comprising indicative information to the host, wherein the indicative information indicates whether the memory system supports the inquiry of the execution status of the program.

18. The method of claim 17, wherein a compute namespace is implemented by a compute engine of the memory system, and the program is executed in the compute namespace.

19. The method of claim 18, wherein:
the memory system further comprises a first memory device accessible by the compute engine for the execution of the program and a second memory device;
input data of the program is copied from the second memory device to the first memory device; and
the first memory device is accessed by the compute engine to retrieve the input data of the program from the first memory device and to store output data of the program in the first memory device.

20. (canceled)

21. The memory system of claim 16, wherein:
the controller is configured to receive and parse a third command that instructs to execute the program; and
the compute engine is configured to execute the program responsive to the third command.

22. The memory system of claim 21, wherein a compute namespace is implemented by the compute engine such that the program is executed in the compute namespace.
